(19) United States
(12) Patent Application Publication
(10) Pub. No.: US 2006/0070065 A1
(43) Pub. Date: Mar. 30, 2006

(54) Memory support for heterogeneous virtual machine guests

(76) Inventors: Vincent J. Zimmer, Federal Way, WA (US); Michael A. Rothman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/952,639

(22) Filed: Sep. 29, 2004

(51) Int. Cl. G06F 9/455

(52) U.S. Cl. 718/1

(57) ABSTRACT

Memory support of heterogeneous virtual machine operating system guests. A virtual machine monitor (VMM) is launched on a computer system. A first virtual machine (VM) supported by the VMM is launched, the first VM to support a first guest operating system (OS). A second VM supported by the VMM is launched, the second VM to support a second guest OS, wherein a number of memory addressing bits of the first guest OS is smaller than a number of memory addressing bits of the second guest OS. Pages for the first guest OS are maintained at a lower level in a guest OS page table hierarchy than pages for the second guest OS in the guest OS page table hierarchy.

### BACKGROUND

1. Field

Embodiments of the invention relate to the field of computer systems and more specifically, but not exclusively, to memory support for heterogeneous virtual machine guests.

2. Background Information

A Virtual Machine (VM) is a software construct that behaves like a complete physical machine. A VM usually has the same features of a physical machine such as expansion slots, network interfaces, disk drives, and a Basic Input/Output System (BIOS). Multiple VMs may be set up and torn down on a computer system. Each VM may support a corresponding Guest operating system (OS) and associated applications.

A Virtual Machine Monitor (VMM) gives each VM the illusion that the VM is the only physical machine running on the hardware. The VMM is a layer between the VMs and the physical hardware to maintain safe and transparent interactions between the VMs and the physical hardware. Each VM session is a separate entity that is isolated from other VMs by the VMM. If one VM crashes or otherwise becomes unstable, the other VMs, as well as the VMM, should not be adversely affected.

Today's virtualization schemes fail to support a mix of 32-bit and 64-bit Guest operating systems on the same physical machine.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of an environment that provides memory support for heterogeneous virtual machine guests in accordance with the teachings of the present invention.

FIG. 2 is a block diagram illustrating one embodiment of an environment that provides memory support for heterogeneous virtual machine guests in accordance with the teachings of the present invention.

FIG. 3 is a block diagram illustrating one embodiment of an environment that provides memory support for heterogeneous virtual machine guests in accordance with the teachings of the present invention.

FIG. 4 is a flowchart illustrating one embodiment of the logic and operations to provide memory support for heterogeneous virtual machine guests in accordance with the teachings of the present invention.

FIG. 5 is a flowchart illustrating one embodiment of the logic and operations to provide memory support for heterogeneous virtual machine guests in accordance with the teachings of the present invention.

FIG. 6 is a flowchart illustrating one embodiment of the logic and operations to provide memory support for heterogeneous virtual machine guests in accordance with the teachings of the present invention.

FIG. 7 is a block diagram illustrating one embodiment of a computer system to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

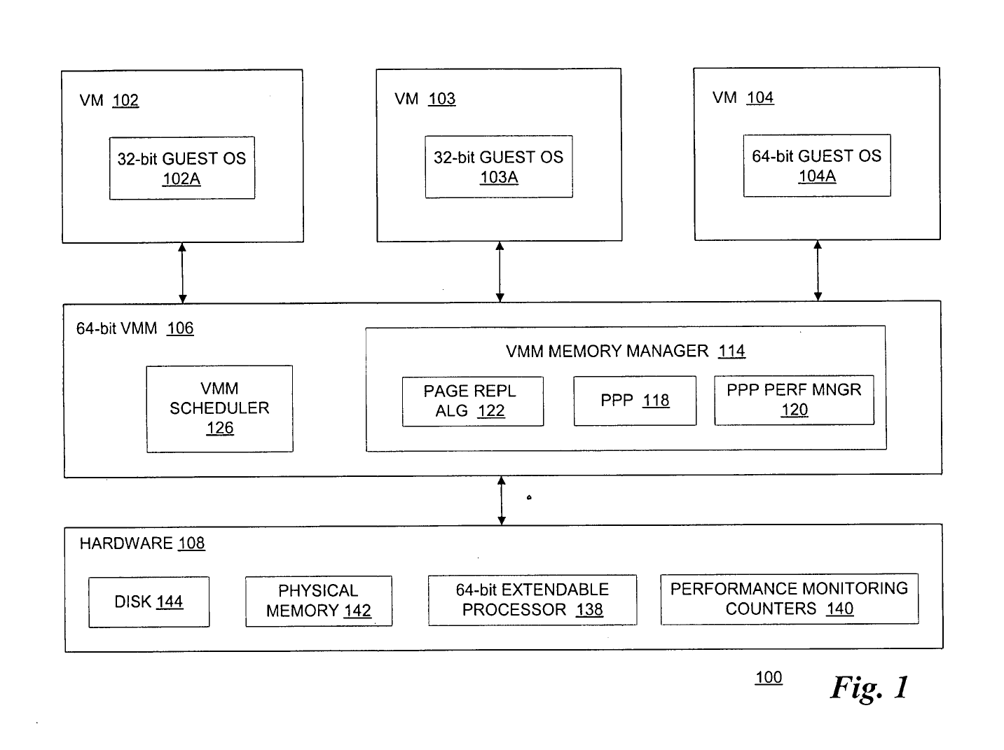

Referring to FIG. 1, one embodiment of a computer system 100 is shown. Computer system 100 includes a Virtual Machine Monitor (VMM) 106 layered on hardware layer 108. VMM 106 supports Virtual Machines (VMs) 102, 103 and 104.

Embodiments of the present invention provide memory support for heterogeneous virtual machine guests. The term “heterogeneous virtual machine guests” refers to the memory addressing capabilities of a guest. For example, Microsoft® Windows XP may be considered a 32-bit guest, while Microsoft OS codenamed “Longhorn” may be considered a 64-bit guest. 32-bit and 64-bit represent the number of bits the guests may use for memory addressing. Embodiments described herein provide memory support for 32-bit guests and 64-bit guests concurrently running in a VM/VMM environment.

Hardware layer 108 includes a 64-bit Extendable Processor 138. 64-bit Extendable Processor 138 includes a 32-bit processor that has memory addressing capabilities up to 64-bits. Processor 138 may include a 32-bit mode to run 32-bit, x86-based applications. Processor 138 may also include a 64-bit mode to execute 64-bit code and to enable 64-bit memory addressing. In one embodiment, processor 138 may be run in at least three scenarios: 1) 32-bit OS and 32-bit applications, 2) 64-bit OS and 32-bit applications, and 3) 64-bit OS and 64-bit applications. It will be understood that embodiments of the present invention may also include 16-bit OS's and applications, such as the Microsoft Disk Operating System (MS-DOS). Examples of processor 138 include, but are not limited to, Intel™ Architecture (IA)-32 processors that incorporate the Intel® Extended Memory 64 Technology (EM64T), processors that incorporate the Advanced Micro Devices® Long Mode, or the like.

Hardware layer 108 may include performance monitoring counters 140. Performance monitoring counters 140 include hardware for monitoring the performance of computer system 100. The performance monitoring counters may record information related to hardware actions and not associated with particular processes or threads. In one embodiment, the performance monitoring counters 140 are part of processor 138 and are in addition to processor 138's architectural register set.

Counters 140 may offer event counting, time sampling, event sampling, or the like. In one embodiment, counters 140 capture micro-architecture events of processor 138, such as the number of cache line misses, the number of split cache line accesses, or the like. In one embodiment, performance monitoring counters 140 are compatible with the Intel® performance monitoring (EMON) tool and the Intel® VTune Performance Analyzer.

VM 102 includes a 32-bit Guest OS 102A, VM 103 includes a 32-bit Guest OS 103A, and VM 104 includes a 64-bit Guest OS 104A. While embodiments herein are described using Guest OS's, it will be understood that alternative embodiments include other guests, such as a Guest System Management Mode (SMM), running in a VM. In one embodiment, VMM 106 operates substantially in compliance with the Extensible Firmware Interface (EFI) (Extensible Firmware Interface Specification, Version 1.10, Dec. 1, 2002, available at http://developer.intel.com/technology/efi).

VMM 106 includes a VMM scheduler 126 and VMM memory manager 114. VMM scheduler 126 coordinates how much access time each VM is provided to processor 138. For example, in computer system 100, each VM may be scheduled an equal amount of time, that is VM 102-104 would each get one-third access time to processor 138. In another example, scheduler 126 may time slice between VM switches by unequal divisions. For example, VM 102 may get access to processor 138 50% of the time, while VM 103 and VM 104 each get access 25% of the time. In one embodiment, VMM scheduler 126 may make adjustments to VM time allocation dynamically while one or VM sessions are up. In another embodiment, VMM scheduler 126 may make time slicing adjustments when a VM is torn down, or an additional VM is powered up.

VMM memory manager 114 manages the allocation of memory and handles memory access requests by VMs 102-104. In one embodiment, VMM 104 uses a memory management unit (MMU) of processor 138 in combination with software techniques to manage memory. VMM 106 gives VMs 102-104 and their respective Guest OS's the illusion that each has exclusive access to memory of computer system 100.

VMM memory manager 114 may include a page placement policy (PPP) 118 and a PPP performance manager 120. The PPP 118 enforces a policy on the page replacement algorithm 122 of the VMM memory manager 114 based on the size of the Guest OS (for example, 32-bit versus 64-bit). PPP performance manager 120 provides a feedback mechanism to dynamically adjust the distribution of VM cycles to the VMs 102-104 by the VMM scheduler 126. In one embodiment, this feedback is provided by performance monitoring counters 140.

In one embodiment, computer system 100 uses virtual memory. In general, virtual memory is a logical construct of memory as viewed by an operating system, and exceeds the amount of physical memory. Programs and data that are currently in use are maintained in physical memory 142, while the rest of virtual memory resides on a disk 144. In one embodiment, disk 144 includes a hard disk of a hard disk drive. Pieces of virtual memory are swapped between physical memory 142 and disk 144. For example, in one embodiment, computer system 100 may include 512 Megabytes (MB) of physical memory 142, but advertises approximately 4 Gigabytes (GB) (2ˆ32) of virtual memory to VM 102 and Guest OS 102A.

VMs 102-104 are provided virtual memory abstractions of physical memory 142. Further, VMM memory manager 114 allows Guests OS's 102A-104A to refer to the same virtual memory address. When a Guest OS attempts to access a memory address, the VMM memory manager 114 performs a virtual to physical memory address translation. The Guest OS is unaware of the physical memory address. For example, each Guest OS 102A-104A may believe it has information stored at virtual address x3000h. But in reality, this virtual address maps to a unique position in virtual memory of computer system 100. In the embodiment of FIG. 1, VMM 106 executes in a 64-bit mode so that VMM 106 may “see” all the virtual memory that 64-bit Guest OS 104A may attempt to access.

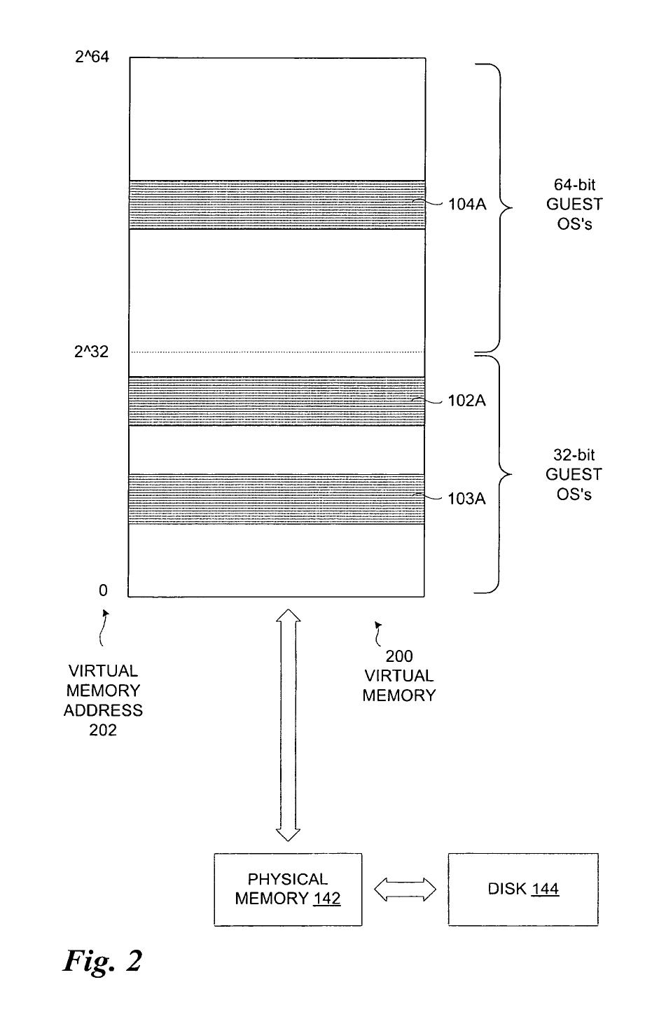

Referring to FIG. 2, an embodiment of virtual memory 200 is shown. In one embodiment, virtual memory 200 is constructed from physical memory 142 using a paging technique. In the embodiment of FIG. 2, virtual memory 200 has virtual memory addresses 202 from 0 to 2ˆ64 (approximately 18 Exabytes).

Paging involves the manipulation of memory between physical and virtual memory. Virtual memory is divided into units called pages. Physical memory has units called page frames that are the same size as pages. The swapping of information between physical memory 142 and disk 144 is made using pages.

A page table is used to map the pages to particular page frames. Usually, a flag is used to indicate which pages are present in physical memory 142 and which are stored on disk 144. If a Guest OS tries to access an address that corresponds to a page not in physical memory 142, than a page fault occurs. The correct page is located on disk 144 and swapped with a page currently in physical memory 142. The procedure to determine which page in physical memory 142 is to be swapped out to disk 144 is referred to as a page replacement algorithm. Such page replacement algorithms may include a clock page replacement algorithm and a least recently used (LRU) page replacement algorithm.

Some paging schemes use a Translation Lookaside Buffer (TLB). In one embodiment, the TLB is a hardware device that allows for the mapping of virtual memory addresses to physical memory addresses without using the page table. The TLB is populated with pages that are expected to be the most requested in order to avoid the time necessary to perform a complete page table lookup. If a requested page is not found in the TLB, then a “normal” page table lookup is performed.

As shown in FIG. 2, 32-bit Guest OS 102A and 103A are placed in virtual memory address space below 4 GB. 64-bit Guest OS 104A is placed in virtual memory address space above 4 GB. In an alternative embodiment, 64-bit Guest OS may be placed below 4 GB.

By maintaining the 32-bit Guest OS's below 4 GB, the overhead associated with address extension schemes to maintain a 32-bit Guest OS above 4 GB is eliminated. Examples of such address extension schemes include physical addressing extensions (PAE), page size extensions (PSE), or the like. PAE may provide 36-bits of memory addressing by introducing extra bits into the page directories and page tables to allow the extension of base addresses of page tables and pages. PSE uses a page directory and no page tables to provide page sizes of 4 MB to create 36-bits of extended memory addressing. Such schemes use extra processing cycles to manage memory accesses that degrade system performance.

In another embodiment, the 32-bit Guest OS's 102A and 103A are assigned more physical memory 142, than 64-bit Guest OS 104A. This may result in fewer page faults for 32-bit Guest OS's 102A and 103A. Fewer page faults results in fewer swaps between physical memory and disk. Page faults usually require time expensive input/output (I/O) operations, such as access to a disk page file. Further, a page miss may require unmapping a page from a different VM for the faulting VM. Fewer time expensive disk swaps results in faster memory access. In one embodiment, assigning more physical memory to 32-bit Guest OS's is a policy of the page placement policy 118.

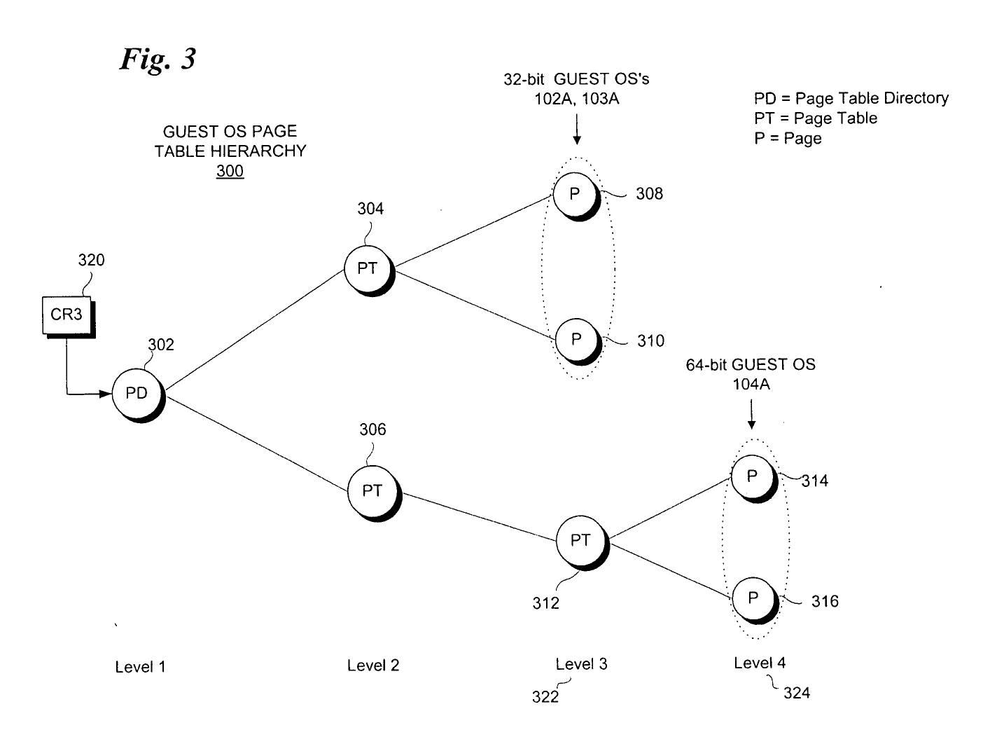

FIG. 3 shows one embodiment of a Guest OS Page Table Hierarchy 300 (hereinafter referred to as “page table hierarchy 300”). Page tables may be arranged in a multilevel structure in order to avoid having to manipulate a large single page table. In one embodiment, page tables of the page table hierarchy 300 may not all reside in physical memory 142 at the same time. It will be understood that embodiments of the present invention are not limited to the number of page directories, page tables, pages, and hierarchy levels shown in FIG. 3.

One embodiment of page table hierarchy 300 includes a combined page table hierarchy for the 32-bit and 64-bit Guest OS's. The VMM manages page table hierarchy 300 and gives each Guest OS the illusion of having its own page directory and associated page tables and pages. The VMM maintains the veritable page directory/page tables for the Guests OS's.

Page table hierarchy 300 begins with a page table directory 302. Page table directory 302 points to page tables 304 and 306. Page table 304 references pages 308 and 310. Pages 308 and 310 are associated with 32-bit Guest OS 102A and 103A. In one embodiment, pages associated with a 32-bit Guest OS also include applications running in the Guest OS.

Page table 306 points to page table 312. Page table 312 in turn points to pages 314 and 316 which are associated with 64-bit Guest OS 104A.

The 32-bit Guest OS's are maintained at a lower level in the page table hierarchy 300 than the 64-bit Guest OS. Fewer page walks are needed to lookup 32-bit Guest OS pages, thus, the lookups of the 32-bit Guest OS's occur faster than the 64-bit Guest OS lookups. In the embodiment of FIG. 3, 32-bit Guest OS's 102A and 103A are kept at level 3, shown at 322, of hierarchy 300, while 64-bit Guest OS 104A is maintained at level 4, shown at 324.

In the embodiment of FIG. 3, the additional page table walk placed on 64-bit Guest OS 104A may not noticeably affect the performance of 64-bit Guest OS 104A. 64-bit Guest OS's inherently incur more memory mapping overhead due the size of their microinstructions. The larger size of 64-bit Guest OS microinstructions may result in poor code density and thus the need for more memory pages. For example, in a 32-bit system, the microinstruction “MOV EAX, 0” may be 7 bytes long, while the same microinstruction in a 64-bit system may be 12 bytes long. The additional time for an extra page walk is of little impact on 64-bit Guest OS performance when compared to the time to handle the size of their microinstructions.

In one embodiment, a Control Register 3 (CR3) 320 points to page table directory 302; CR3 is a page directory base register. In one embodiment, CR3 is a register of processor 138. The VMM sets CR3 and maintains control over CR3. In a non-VM environment, the OS may normally set and access CR3 for memory management activity. However, in the VM/VMM environment, memory management is controlled by the VMM, so the Guest OS is isolated from access to CR3. In one embodiment, the VMM may advertise a “virtual CR3” to each VM. In another embodiment, a request to access CR3 by a Guest OS may constitute a VMM exit event (discussed further below).

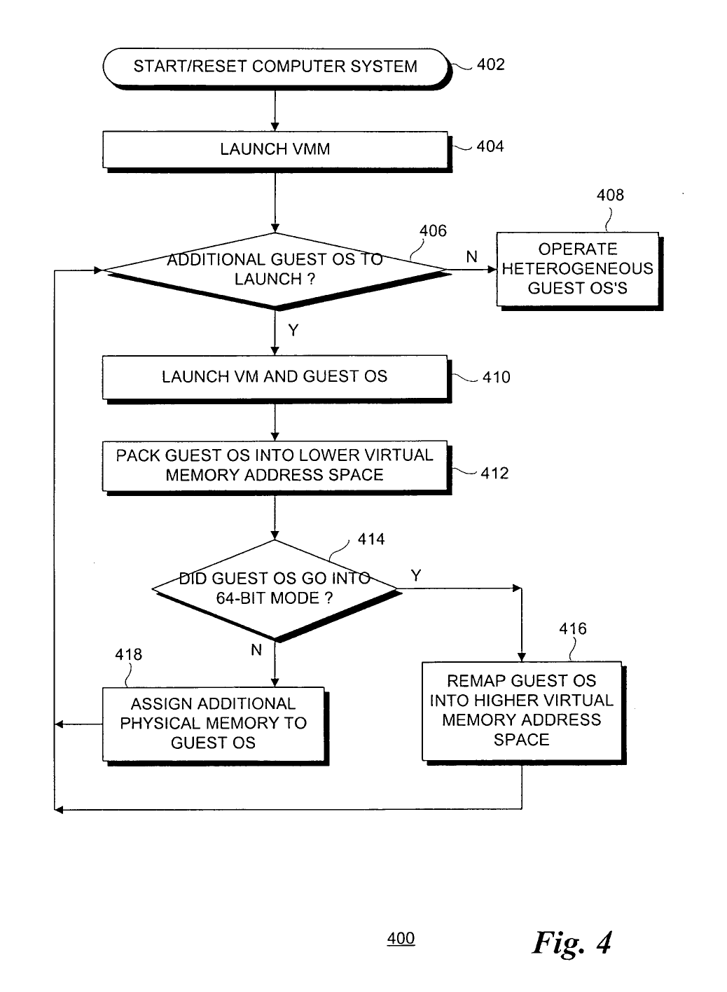

Turning to FIG. 4, a flowchart 400 illustrates the logic and operations for memory support of heterogeneous virtual machine Guest OS's in accordance with one embodiment of the present invention. Beginning in a block 402, a computer system is reset/started. In one embodiment, instructions stored in non-volatile storage are loaded. In one embodiment, the instructions may begin initializing the platform by conducting a Power-On Self-Test (POST) routine. In another embodiment, the computer system is awakened from a sleep state.

Continuing to a block 404, a VMM is launched on the computer system. In one embodiment, the VMM is loaded from a local storage device, such as disk 142. In another embodiment, the VMM is loaded across a network connection from another computer system.

Proceeding to a decision block 406, the logic determines if there are any additional Guest OS's to launch. If the answer is no, then the logic proceeds to a block 408 to operate the heterogeneous Guest OS's.

If the answer to decision block 406 is yes, then the logic proceeds to a block 410. In block 410, a VM and its associated Guest OS is launched. In block 412, the Guest OS is packed into a lower virtual memory address space. In one embodiment, this lower virtual memory address space is below 4 GB. In this particular embodiment, the logic assumes a 32-bit Guest OS, so any Guest OS is initially placed below 4 GB.

Continuing to a decision block 414, the logic determines if the Guest OS has gone into a 64-bit mode. If the answer is yes, then the logic proceeds to a block 416. In block 416, the 64-bit Guest OS is remapped into a higher virtual memory address space. In this way, the lower virtual memory address spaces may be saved for use by 32-bit Guest OS's and applications. In one embodiment the higher virtual memory address space is above 4 GB. After block 416, the logic proceeds back to decision block 406 to launch any additional Guest OS's.

If the answer to decision block 414 is no, then the logic proceeds to a block 418 to assign additional physical memory to the Guest OS. In this way, the 32-bit Guest OS may avoid page faults that hinder performance. After block 418, the logic returns to decision block 406.

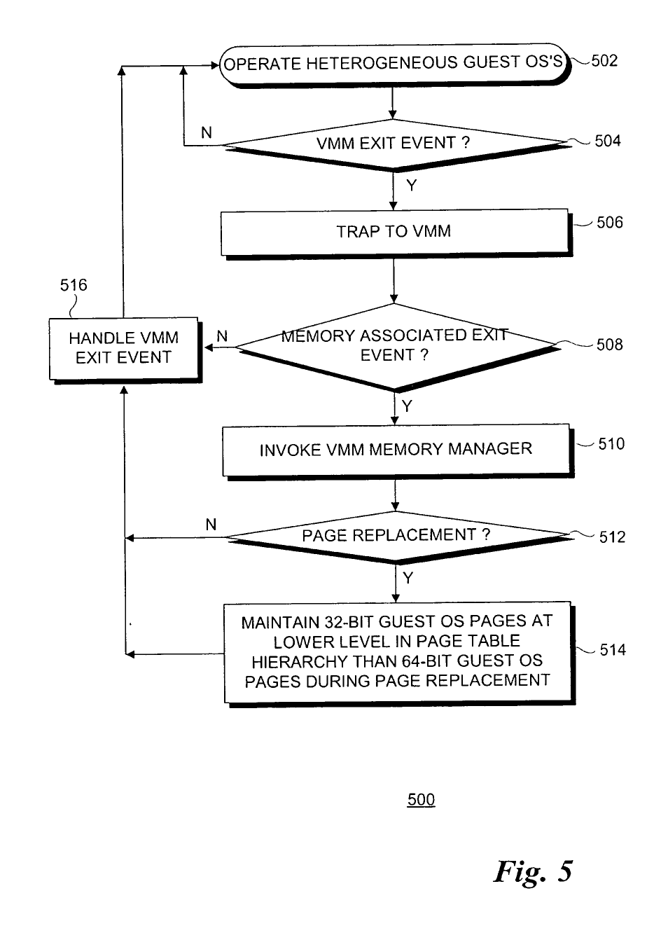

Referring to FIG. 5, a flowchart 500 illustrates the logic and operations for memory support of heterogeneous virtual machine guests in accordance with one embodiment of the present invention. Beginning in a block 502, heterogeneous Guest OS's are operating in a VM/VMM environment. In block 502, the VMM may time slice the access of the VMs to a processor of computer system. Also, VMs may be setup and torn down by users of the computer system.

Proceeding to a decision block 504, the logic determines if a VMM exit event has occurred. The VMM may take control whenever a Guest OS attempts to perform an operation that may affect the other VMs or the VMM itself. Such an “out of bounds” action by a Guest OS may be referred to as a VMM exit event (discussed further below). If the answer to decision block 504 is no, then the logic returns to block 502. If the answer is yes, then the logic proceeds to block 506 to trap to the VMM.

In one embodiment, a VMM exit event includes an attempted action by a Guest OS that may de-isolate the Guest OS from its VM. Embodiments of a VMM exit event include, but are not limited to, a Guest OS attempting to enable interrupts, a Guest OS attempts to access a machine specific register, a Guest OS attempts a CR3 access, a Guest OS attempts to flush a TLB entry, a Guest OS attempts to access illegal pages, a Guest OS page fault, or the like.

In one embodiment, a “virtual CR3” is presented to each Guest OS by the VMM. When a Guest OS attempts to touch its “virtual CR3,” a VMM exit event is triggered and a trap to the VMM occurs.

In one embodiment, processor 138, due to virtualization hardware, may detect VMM exit events. In one embodiment, processor 138 includes a virtualization mode. This virtualization mode may catch a VMM exit event that is missed by the VMM and trigger a trap to the VMM. The virtualization hardware of processor 138 may shore up “virtualization holes” that exist in the instruction set architecture. Since processor 138 may detect a VMM exit event and trap to the VMM, a virtualization failure may be avoided.

Proceeding to a decision block 508, the logic determines if the VMM exit event was associated with memory. If the answer is no, then the logic proceeds to a block 516 to handle the VMM exit event accordingly, and then proceed back to block 502.

If the answer to decision block 508 is yes, then the logic proceeds to a block 510 to invoke the VMM memory manager. The VMM memory manager may take appropriate action based on the VMM exit event.

Continuing to a decision block 512, the logic determines if a page replacement operation is to occur in order to process the VMM exit event. If the answer is no, then the logic proceeds to block 516 to handle the VMM exit event. If the answer to decision block 512 is yes, then the logic proceeds to a block 514.

In block 514, the page replacement algorithm of the VMM memory manager maintains 32-bit Guest OS pages at a lower level in the page table hierarchy than 64-bit Guest OS pages during a page replacement procedure. This policy may be enforced by the page placement policy of the VMM memory manager. After block 514, the logic proceeds to block 516 to handle any other tasks associated with the VMM exit event.

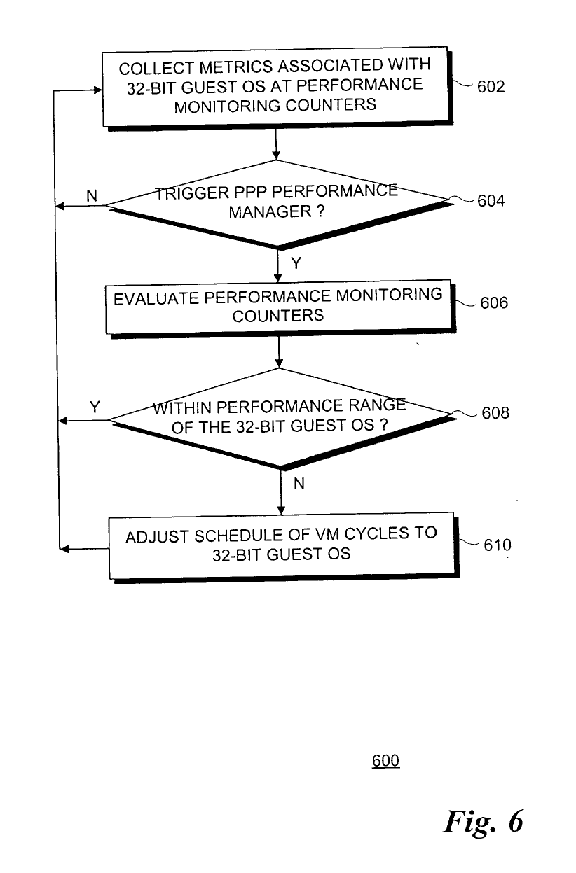

Turning to FIG. 6, a flowchart 600 illustrates the logic and operations for performance monitoring of memory support of heterogeneous virtual machine guests in accordance with an embodiment of the present invention. Flowchart 600 is described in connection with a single 32-bit Guest OS for the sake of clarity, however, it will be understood that in one embodiment the logic and operations of flowchart 600 may be applied to multiple 32-bit Guest OS's concurrently.

Beginning in a block 602, metrics associated with the performance of a 32-bit Guest OS are collected at performance monitoring counters. Proceeding to a decision block 604, the logic determines if the PPP performance manager has been triggered. In one embodiment, the PPP performance manager may be triggered by pre-determined time schedule; in another embodiment, particular events in the VMM/VM environment may trigger the PPP performance manager.

If the answer to decision block 604 is no, then the logic returns to block 602. If the answer to decision block 604 is yes, then the logic proceeds to a block 606 to evaluate the performance monitoring counters. Embodiments of items evaluated include, but are not limited to, L2 transactions, memory bus transactions, cache line transactions, or the like. In one embodiment, the PPP performance manager may retrieve information from the performance monitoring counters using function calls from C libraries.

Continuing to a decision block 608, the logic determines if a performance metric is within a performance range of the 32-bit Guest OS. In one embodiment, the performance range may be determined by the number of VMs up, the sizes of the VM guests, or the like.

If the answer to decision block 608 is yes, then the logic returns to block 602. If the answer to decision block 608 is no, then the logic proceeds to a block 610. In block 610, the VM cycles provided to the 32-bit Guest OS are adjusted in order to bring the 32-bit Guest OS within the performance range.

For example, if the 32-bit Guest OS is performing too slow based on the collected metrics, then additional VM cycles may be provided to the 32-bit Guest OS. Conversely, if the 32-bit Guest OS is performing better than the performance range, then the number of VM cycles provided to this 32-bit OS guest may be reduced so that the any “extra” VM cycles may be more efficiently used with other Guest OS's. In this example, the “extra” VM cycles may not provide enough performance improvement of the 32-bit Guest OS to warrant depriving another VM of these “extra” cycles.

In one embodiment, the VMM scheduler may make the adjustments in VM cycles to the 32-bit Guest OS in order to maximize the performance of the 32-bit Guest OS. It will be understood that in some situations, the VMM scheduler may not take away too many VM cycles from any 64-bit guests as to dramatically affect the performance of any 64-bit guests.

It will be appreciated that the performance monitoring and the VM cycling adjustments may occur dynamically during the life of a VM and its associated guest. For example, a 32-bit Guest OS user may be using a word processor application that does not over tax the current VM cycle schedule of the VM. However, the user may begin using a Computer Aided Design (CAD) application that is memory intensive and overburdens the VM. In accordance with embodiments herein, feedback provided by performance monitoring counters may result in additional VM cycles dynamically supplied to this particular VM.

Thus, embodiments described herein may give users of 32-bit operating systems a commensurate experience in a VM/VMM environment. In one embodiment, 32-bit Guest OS's are placed in a lower level of a page table hierarchy as compared to 64-bit Guest OS's to lessen the number of page table walks. In another embodiment, the amount of physical memory allocated to 32-bit Guest OS's is greater than the amount given to 64-bit Guest OS's to reduce the number of page faults by the 32-bit Guest OS's. In yet another embodiment, memory performance is monitored so that the distribution of VM cycles may be allocated to maximize the performance of 32-bit Guest OS's. In another embodiment, 32-bit Guest OS's are maintained below 4 GB in order to avoid the overhead associated with addressing extension schemes, such as PAE and PSE.

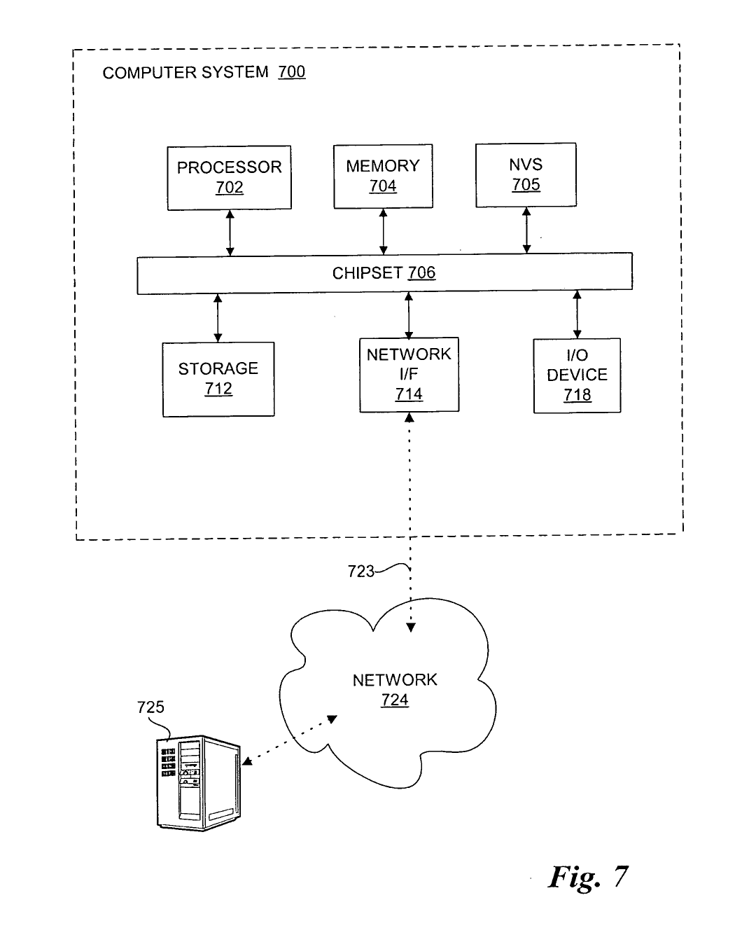

FIG. 7 is an illustration of one embodiment of an example computer system 700 on which embodiments of the present invention may be implemented. Computer system 700 includes a processor 702 and a memory 704 coupled to a chipset 706. Storage 712, non-volatile storage (NVS) 705, network interface 714, and Input/Output (I/O) device 718 may also be coupled to chipset 706. Embodiments of computer system 700 include, but are not limited to a desktop computer, a notebook computer, a server, a personal digital assistant, a network workstation, or the like.

Processor 702 may include, but is not limited to, an Intel Corporation processor, an AMD Corporation processor, or the like, that has a 64-bit extendable capability. In one embodiment, computer system 700 may include multiple processors. Memory 704 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like.

Chipset 706 may include a Memory Controller Hub (MCH), an Input/Output Controller Hub (ICH), or the like. Chipset 706 may also include system clock support, power management support, audio support, graphics support, or the like. In one embodiment, chipset 706 is coupled to a board that includes sockets for processor 702 and memory 704.

Components of computer system 700 may be connected by various buses including a Peripheral Component Interconnect (PCI) bus, a System Management bus (SMBUS), a Low Pin Count (LPC) bus, a Serial Peripheral Interface (SPI) bus, an Accelerated Graphics Port (AGP) interface, or the like. I/O device 718 may include a keyboard, a mouse, a display, a printer, a scanner, or the like.

The computer system 700 may interface to external systems through the network interface 714. Network interface 714 may include, but is not limited to, a modem, a network interface card (NIC), or other interfaces for coupling a computer system to other computer systems. A carrier wave signal 723 is received/transmitted by network interface 714. In the embodiment illustrated in FIG. 7, carrier wave signal 723 is used to interface computer system 700 with a network 724, such as a local area network (LAN), a wide area network (WAN), the Internet, or any combination thereof. In one embodiment, network 724 is further coupled to a remote computer 725 such that computer system 700 and remote computer 725 may communicate over network 724.

The computer system 700 also includes non-volatile storage 705 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 712 includes, but is not limited to, a magnetic hard disk, a magnetic tape, an optical disk, or the like. It is appreciated that instructions executable by processor 702 may reside in storage 712, memory 704, non-volatile storage 705, or may be transmitted or received via network interface 714.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., read only memory (ROM), random access memory (RAM), magnetic disk storage media, optical storage media, a flash memory device, etc.). In addition, a machine-accessible medium may include propagated signals such as electrical, optical, acoustical or other forms of propagated signals (e.g., carrier waves, infrared signals, digital signals, etc.).

It will be appreciated that in one embodiment, computer system 700 may execute operating system (OS) software. For example, one embodiment of the present invention utilizes Microsoft Windows® as the operating system for computer system 700. Other operating systems that may also be used with computer system 700 include, but are not limited to, the Apple Macintosh operating system, the Linux operating system, the Unix operating system, or the like.

In one embodiment, computer system 700 employs the Intel® Vanderpool Technology (VT). VT may provide hardware support to facilitate the separation of VMs and the transitions between VMs and the VMM.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. A method, comprising:
launching a virtual machine monitor (VMM) on a computer system;
launching a first virtual machine (VM) supported by the VMM, the first VM to support a first guest operating system (OS);
launching a second VM supported by the VMM, the second VM to support a second guest OS, wherein a number of memory addressing bits of the first guest OS is less than a number of memory addressing bits of the second guest OS; and
maintaining pages for the first guest OS at a lower level in a guest OS page table hierarchy than pages for the second guest OS in the guest OS page table hierarchy.

2. The method of claim 1 wherein the first guest OS includes a 32-bit guest OS and the second guest OS includes a 64-bit guest OS.

3. The method of claim 1, further comprising maintaining the first guest OS below a virtual memory address that does not require the use of an address extension scheme for the first guest OS.

4. The method of claim 1, further comprising adjusting a VMM scheduler of the VMM to give the first guest OS more VM cycles if the performance of the first guest OS is outside of a performance range.

5. The method of claim 4, further comprising evaluating performance monitoring counters associated with a processor of the computer system.

6. The method of claim 1 wherein the VMM to use the same number of memory addressing bits as the second guest OS.

7. The method of claim 1, further comprising trapping to the VMM if a VMM exit event occurs, wherein the VMM exit event includes a request to access the guest OS page table hierarchy by the first guest OS.

8. The method of claim 1, further comprising assigning more physical memory to the first guest OS than to the second guest OS.

9. An article of manufacture comprising:
a machine-accessible medium including a plurality of instructions which when executed perform operations comprising:
launching a virtual machine monitor (VMM) on a computer system;
launching a first virtual machine (VM) supported by the VMM, the first VM to support a 32-bit guest operating system (OS);
launching a second VM supported by the VMM, the second VM to support a 64-bit guest OS; and
maintaining pages for the 32-bit guest OS at a lower level in a guest OS page table hierarchy than pages for the 64-bit guest OS in the guest OS page table hierarchy during a memory page replacement algorithm of the VMM.

10. The article of manufacture of claim 9 wherein execution of the plurality of instructions further perform operations comprising:
packing the 32-bit guest OS below a virtual memory address of 4 gigabytes;
packing the 64-bit guest OS below the virtual memory address of 4 gigabytes; and
remapping the 64-bit guest OS above the virtual memory address of 4 gigabytes.

11. The article of manufacture of claim 9 wherein execution of the plurality of instructions further perform operations comprising adjusting a VMM scheduler of the VMM to give the 32-bit guest OS more VM cycles if the performance of the 32-bit guest OS is outside of a performance range.

12. The article of manufacture of claim 11 wherein execution of the plurality of instructions further perform operations comprising evaluating performance monitoring counters of the computer system to determine if the 32-bit guest OS is operating outside of the performance range.

13. The article of manufacture of claim 9 wherein execution of the plurality of instructions further perform operations comprising trapping to the VMM if the 32-bit guest OS attempts to access a control register of a processor of the computer system, wherein the control register is associated with the guest OS page table hierarchy.

14. The article of manufacture of claim 9 wherein execution of the plurality of instructions further perform operations comprising assigning additional physical memory to the 32-bit guest OS.

15. The article of manufacture of claim 9 wherein the plurality of instructions capable of operating with a 64-bit extendable processor of the computer system, wherein the 64-bit extendable processor includes a 32-bit mode and a 64-bit mode.

16. A system, comprising:
a 32-bit guest operating system (OS) executing in a first virtual machine (VM);
a 64-bit guest OS executing in a second VM; and
a virtual machine monitor (VMM) supporting the first and second VMs, wherein the VMM to maintain pages for the 32-bit guest OS at a lower level in a guest OS page table hierarchy than pages for the 64-bit guest OS in the guest OS page table hierarchy.

17. The system of claim 16 wherein the VMM comprises:
a page replacement algorithm; and
a page placement policy associated with the page replacement algorithm, the page placement policy to enforce maintaining pages for the 32-bit guest OS at a lower level in the guest OS page table hierarchy than pages for the 64-bit guest OS.

18. The system of claim 17 wherein the VMM includes a page placement policy performance manager to evaluate the performance of the 32-bit guest OS.

19. The system of claim 18, further comprising performance monitoring counters to provide metrics associated with the 32-bit guest OS to the page placement policy performance manager.

20. The system of claim 18, further comprising a VMM scheduler, the VMM scheduler to adjust VM cycles distributed to the 32-bit guest in response to an evaluation of the performance of the 32-bit guest OS by the page placement policy performance manager.

21. The system of claim 16, further comprising a 64-bit extendable processor, wherein the 64-bit extendable processor includes a 32-bit mode and a 64-bit mode.

22. The system of claim 21 wherein the 64-bit extendable processor includes virtualization hardware.

23. The system of claim 16 wherein the 32-bit guest OS is assigned more physical memory than the 64-bit guest OS.

24. The system of claim 16 wherein the 32-bit guest OS is maintained below a virtual memory address of 4 gigabytes.

25. A computer system, comprising:
a processor;
an Synchronized Dynamic Random Access Memory (SDRAM) unit coupled to the processor; and
a machine-accessible medium coupled to the processor, the machine-accessible medium including a plurality of instructions which when executed by the processor perform operations comprising:
launching a first virtual machine (VM) supported by a VMM of the computer system, the first VM to support a first guest operating system (OS);
launching a second VM supported by the VMM, the second VM to support a second guest OS, wherein a number of memory addressing bits of the first guest OS is less than a number of memory addressing bits of the second guest OS; and
maintaining pages for the first guest OS at a lower level in a guest OS page table hierarchy than pages for the second guest OS in the guest OS page table hierarchy during a memory page replacement algorithm of the VMM.

26. The computer system of claim 25 wherein execution of the plurality of instructions further perform operations comprising adjusting time slicing of the processor between the first guest OS and the second guest OS in response to a page placement policy performance manager of the VMM, wherein the page placement policy performance manager evaluates performance metrics associated with the SDRAM unit.

27. The computer system of claim 26 wherein the performance metrics includes information stored by performance monitoring counters of the computer system.

28. The computer system of claim 25 wherein execution of the plurality of instructions further perform operations comprising assigning more memory space of the SDRAM unit to the first guest OS than to the second guest OS.
